(19) United States
(12) Patent Application Publication
(10) Pub. No.: US 2007/0138212 A1
(43) Pub. Date: Jun. 21, 2007

(54) Resealable, reuseable, insertable bottle assembly for open beverage containers containing wine, carbonated drink and the like, for preservation against environmental degradation

(76) Inventor: Robert Greenbaum, Huntington, NY (US)

Correspondence Address: Mitchell A. Stein, Esq.;STEIN LAW, P.C., Suite 4, 24 Woodbine Avenue, Northport, NY, 11768, US

(21) Appl. No.: 11/313,396

(22) Filed: Dec. 21, 2005

(51) Int. Cl. B67D 5/40

(52) U.S. Cl. 222/383.1

(57) ABSTRACT

A resealable, reuseable, insertable bottle assembly for open beverage containers containing wine, carbonated drink and the like, for preservation against environmental degradation, having a deployable and retractable flexible material for engagement against the drink, a plurality of hinged leaves for engagement with the flexible material at a multiplicity of locations for deployment and retraction further having a spring, a coupling for coupling the hinged leaves, insertion/extraction device for inserting and extracting the assembly, a device for causing the leaved means to move from deployment to retraction. The assembly further includes a gasket as well as telescoping ability for extending and retracting the assembly to enable various levels of drink. In one embodiment, deployment to retraction occurs by way of a cranking for deploying a cable to enable winding and unwinding for deployment and retraction, respectively. Another embodiment includes a cammed assembly having a plurality of shafts separated by vacant spaces wherein the terminal end of each shaft is curved so as to urge consecutive movement from a shaft end to a space such that the assembly is deployed when the terminal end is in the space and retracted when the terminal end is in the shaft space, a cam for interacting with the shafts such that when the cam engages the curved terminal end, it is urged consecutively from shaft to space, the spring presses the cam for urging, and a knob or handle is provided to enable insertion/extraction and deployment/retraction.

### FIELD OF THE INVENTION

The present invention relates to the field of beverages that have been opened from an initial seal or are otherwise unsealed, uncapped or uncorked and contained in a bottle or other fluted neck vessel (like wine or other bottled drinks) or containers (like juice), wherein such beverages by their nature are air or otherwise labile to environmental degradation such that the contents, despite the user's desire, degrade or otherwise change in constituency and/or flavor over time either by microbial or other action (e.g., fermentation) or by loss of critical ingredients (e.g., carbonation or Vitamin C) or the like when such beverages are not completed by the consumer but are desired to be consumed in the future without such degradation. More particularly, this invention relates to reuseable, reasalable, insertable assemblies for such beverage containers, including, without limitation, wines, carbonated drinks, container drinks and the like where freshness after opening and a time delay prior to further consumption are of import to the consumer.

### BACKGROUND OF THE INVENTION

More often then not, when one drinks from a container or bottle of wine, soda, juice or the like, a good portion is wasted because it is not immediately consumed. In the case of wine, fermentation commences virtually immediately, and by days' end, unless sealed with no air, the wine is ruined. Devices exist that evacuate the wine bottle, but are cumbersome, expensive and generally unreliable. Certainly such devices are not employable for usage at large.

Likewise, with carbonated beverages, as the container remains open, the carbonation is lost. It is also well known that for juices, like orange juice, beyond contamination with bacteria lies the harsh reality that nutrients (like Vitamin C) are air labile, and hence dissipate quite rapidly.

U.S. Pat. No. 6,607,105 to Phelps, et al. shows one such example wherein the wine bottle is capped and nitrogen pumped to eliminate air. This device is inherently expensive, and the interaction of the nitrogen potentially toxic. U.S. Pat. No. 6,607,100 shows cooling and dispensing of wine, where refrigeration is added to the nitrogen pump. It should be appreciated that the instant device can be refrigerated in a typical refrigerator, and there is no need for nitrogen or other pumps or materials.

It is an object of the instant invention to provide a mechanism whereby open beverage containers can be sealed from the atmosphere, so as to prevent degradation of the beverage. Known in the art are devices which use a vacuum or otherwise to remove air from within the bottle and then seal the bottle to prevent air from entering the container. It is an object of this invention to avoid the use of such devices.

It is a further object of the instant invention to provide a mechanism whereby open beverage containers of different shapes and sizes can be sealed from the atmosphere so as to prevent degradation of the beverage.

It is a still further object of the instant invention to provide an extendable mechanism whereby open beverage containers can be sealed from the atmosphere, so as to prevent degradation of the beverage. Said extendable mechanism is designed to facilitate storage.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a resealable, reuseable, insertable bottle assembly for open beverage containers containing wine, carbonated drink and the like, for preservation against environmental degradation, having a deployable and retractable flexible material for engagement against the drink, a plurality of hinged leaves for engagement with the flexible material at a multiplicity of locations for deployment and retraction further having a spring, a coupling for coupling the hinged leaves, insertion/extraction device for inserting and extracting the assembly, a device for causing the leaved means to move from deployment to retraction.

The assembly further includes a gasket as well as telescoping ability for extending and retracting the assembly to enable various levels of drink.

In one embodiment, deployment to retraction occurs by way of a cranking for deploying a cable to enable winding and unwinding for deployment and retraction, respectively.

Another embodiment includes a cammed assembly having a plurality of shafts separated by vacant spaces wherein the terminal end of each shaft is curved so as to urge consecutive movement from a shaft end to a space such that the assembly is deployed when the terminal end is in the space and retracted when the terminal end is in the shaft space, a cam for interacting with the shafts such that when the cam engages the curved terminal end, it is urged consecutively from shaft to space, the spring presses the cam for urging, and a knob or handle is provided to enable insertion/extraction and deployment/retraction.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is perspective view of a preferred embodiment of the subject invention showing a bottle of fluid, wine in this instance, already opened and exposed to the elements, with the preferred embodiment poised for insertion and removable sealability and extraction;

FIG. 2 is a perspective view of a preferred embodiment of the subject invention showing the insertion assembly in a fully extended view which, in comparison to FIG. 1, demonstrates the deployed device in an essentially sealable manner when inserted into a bottle;

FIG. 3 is a breakaway drawing showing an exploded component view of the various components of a preferred embodiment of the subject invention in accordance with FIG. 2;

FIG. 4 is a cross-sectional view of an exploded portion 4 of FIG. 3, in accordance with a preferred embodiment of the subject invention showing an upper compressible spring-loaded flange assembly portion thereof;

FIG. 5 is a cross-sectional view of an exploded portion of flange portion 5 of FIG. 3, in accordance with a preferred embodiment of the subject invention showing a lower spring-loaded arcuate flange assembly portion thereof;

FIG. 6 is a cross-sectional view of an exploded version of portion 6 of FIG. 3, in accordance with a preferred embodiment of the subject invention showing the extendability of the leaves in the deployed view for sealable engagement of the device;

FIG. 7 is a cross-sectional view of an exploded version of portion 7 of FIG. 3, in accordance with a preferred embodiment of the subject invention showing the mechanism for extension of the hinged leaves with a gasket attaching to the sidewall of a bottle for sealability, all as shown in greater detail below;

FIG. 8 is a cross-sectional view of an exploded version of portion 8 of FIG. 3, in accordance with a preferred embodiment of the subject invention showing the crankable mechanism for insertion and extraction of the sealable connection at and from fluid line in the bottle to create the sealability and the forcing out of air, and to permit folding and extraction for consumption of the beverage contained therein;

FIG. 9 is a cross-sectional view of the partial insertion of the mechanism in a bottle containing fluid prior to deployment of the hinged leaves and engagement thereof at the surface line of the fluid in the open bottle position, in accordance with a preferred embodiment of the subject invention;

FIG. 10 is a cross-sectional view of a fully inserted mechanism in a bottle, showing a partial extension of the hinged leaves just prior to engagement at the surface line of the fluid in the open bottle position, in accordance with a preferred embodiment of the subject invention;

FIG. 11 is cross-sectional view of the preferred embodiment in a fully deployed view in connection with the fluid-level, wherein the air displaced travels upwardly through the tubular assembly as it is displaced, as one of ordinary skill in the art will well recognize upon reading the subject specification and claims, in accordance with a preferred embodiment of the subject invention;

FIG. 12 is a partial cross-sectional view, as shown in FIG. 1, wherein the hinged leaves with gasket abuts the wall of the bottle and thereby provides sealable connectability, in accordance with a preferred embodiment of the subject invention;

FIG. 13 is a cross-sectional view along circular dotted view of FIG. 11 showing the fully extended arcuate flange assembly, in accordance with a preferred embodiment of the subject invention;

FIG. 14 is a mechanically moved view showing the arcuate flange assembly of FIG. 13 recessed in an aperture as the mechanism is in the process of removal from the bottle in order to provide drinking from the bottle upon complete removal of the device, in accordance with a preferred embodiment of the subject invention;

FIG. 15 is a further mechanically moved view showing the arcuate flange assembly of FIG. 13 fully recessed in the aperture such that the extended hinged leaves are subject to retraction in the process of removal of the device from the bottle in order to provide drinking from the bottle, in accordance with a preferred embodiment of the subject invention;

FIG. 16 is a breakaway drawing showing the various components of a second preferred embodiment of the subject invention wherein deployment and retraction are accomplished in a manner alternative to that of FIG.'s 1-15, utilizing a cammed assembly as more fully described hereinbelow, in accordance with a second preferred embodiment of the subject invention;

FIG. 17 is a cut-away view of the cammed portion of FIG. 16 wherein the assembly is deployed for sealability against the fluid in accordance with a second preferred embodiment of the subject invention;

FIG. 18 is a cut-away view of the cammed portion of FIG. 16 in a motional view showing retraction of the device via the cammed assembly for removal from the bottle, in accordance with a second preferred embodiment of the subject invention showing the springably loaded mechanism urged into a non-deployed state;

FIG. 19 is a cross-sectional drawing showing the various components of the second preferred embodiment of the subject invention in an inserted but non-deployed state;

FIG. 20 is a cross-sectional view showing the various components of the second preferred embodiment of the subject invention, showing the mechanism in a fully deployted state;

FIG. 20A shows a cross-sectional, cut-away view of one of a plurality of o-rings acting as columnar supports to stabilize the device during use in accordance with a second preferred embodiment of the subject invention; and

FIG. 21 is an exploded view of the deployed mechanism in a boxed style fluid container, like that used for juices, in accordance with the second preferred embodiment of the invention, showing full deployment.

### DETAILED DESCRIPTION OF THE PREFERRED EMBODIMENTS

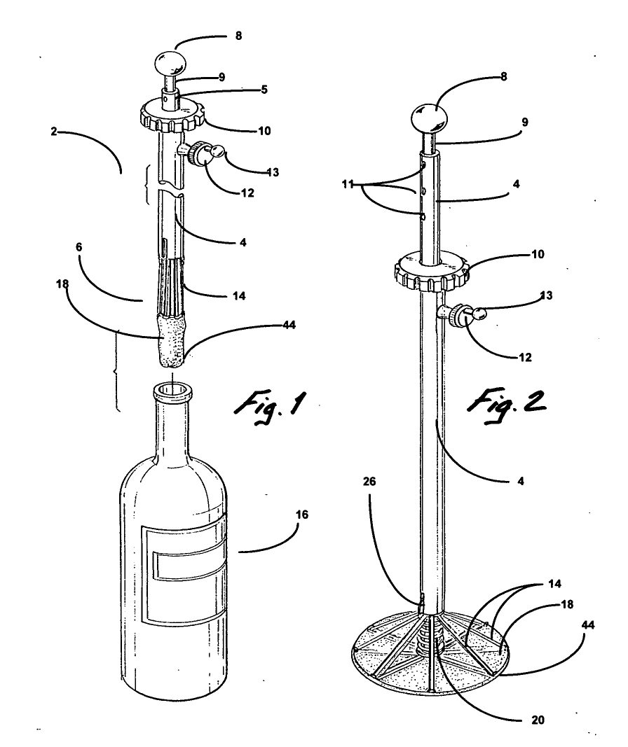

In accordance with the subject invention, FIG. 1 shows a fluted bottle 16 (as used for wine or other types of beverages) which, in typical fashion, has been opened by a person who desires to retain either the non-fermentation of the product contained therein as in, for example, wine, or the carbonation or other attributes of the fluid, preventing microbial or other environmental degradation or unsanitary conditions. Therefore, the device 2 is shown in prone state poised for insertion into the partially filled bottle 16.

As shown in FIG. 1, the device 2 comprises knob 8 for pressurized insertion as well twistable removal as shown in further detail hereinbelow. Knob 8 rigidly attached to internal shaft 9 which passes through external shaft 4 to engage hinged leaves 14 which are attached to flexible material 18 which further contains rubberized gasket 44. Shown in greater detail hereinbelow, as knob 8 is pressed through shaft 4, hinged leaves 14 are caused to be extended, such that material 18 is, as well extended and gasket 44 urged to pressed engagement against bottle 16's internal face such that a virtual sealing action occurs. In this embodiment, material 18 is comprised of a non-air and fluid permeable, flexible material, like a polyurethane, as is gasket 44, wherein gasket 44 is bulbous in nature, as shown in the drawings to create virtual sealable compression against the inner wall of bottle 16. As one can perceive of ordinary skill in the art, armed with the invention as disclosed and claimed, as device 2 is inserted into bottle 16, device 2 permits air to escape therethrough, as it is hollow in nature, such that air may be displaced as device 2 is inserted, but once inserted and deployed, air can no longer engage the fluid remaining in bottle 16.

As shown in FIG. 1, device 2 further comprises crank 13 which is disposed from the center of handle 12, such that spinnable ability is created as crank 13 is engaged, thereby by turning handle 12 which, as shown in further embodiments, engages a pulley for loosening a cable assembly to deploy in a fanned manner material 18 in use for sealable connection against the fluid line in the bottle, and to compressably retract when rewound for retraction and extraction of the device, all as shown in the Figures, and as explained hereinbelow. FIG. 1 also shows leaves 14 in a non-deployed state in an extenable apparatus 6, as shown in greater detail hereinbelow.

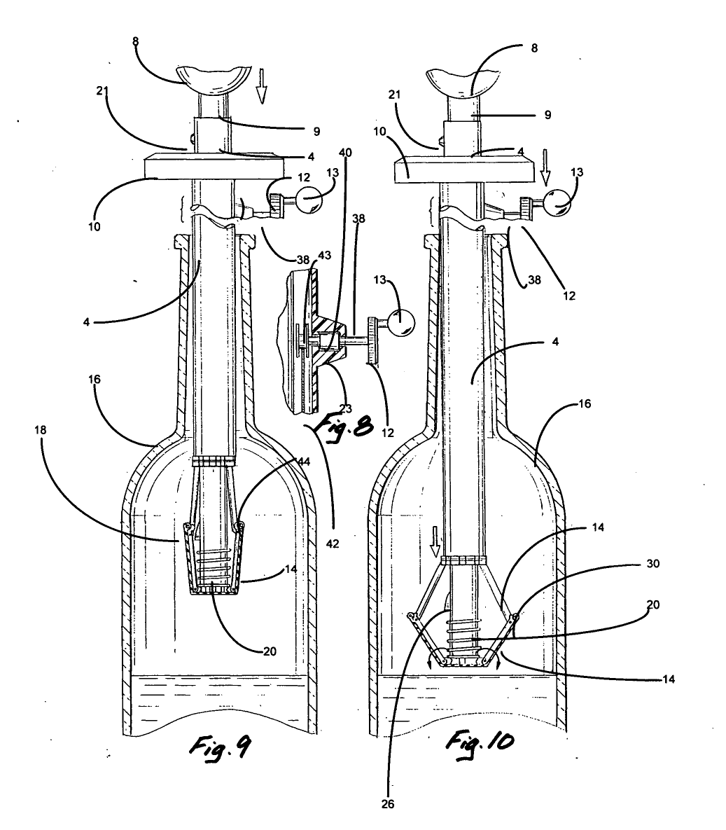

As shown in FIG. 2, a deployed state of device 2, device 2 comprises knob 8 for insertion as well as removal. Knob 8 is attached to internal shaft 9 which passes through external shaft 4. Attached to internal shaft 9 and running through external shaft 4 is a spring loaded, curvilinear flange 26. Spring loaded flange 26 comprises both the curvilinear portion and is comprised of a springable material, preferably spring steel (See FIG. 5), such that element 15 (in FIG. 5) which, when fully extended, latches and extends rubber gasket 44 urged outwardly against the inside of the bottle 16 via hinged leaves 14, thereby urging flexible material 18 against the internal wall of bottle 16 and creating a virtually air-tight seal against the fluid in bottle 16 via gasket 44 (see also FIG. 7). Likewise, as a result of the curvilinear structure of flange 26, and the springable material 15, as retraction occurs, the curve is followed and permitted, as further shown in FIG.'s 13, 14 and 15.

Also shown in FIG. 2 (and in FIG. 1) is cap 10 which is employed for grabality of the device for insertion/extraction and for pressure against the top flute of the bottle 16. As well, FIG. 2 shows spring 20 which compresses in deployment and urges folding of the hinged leaves 14 after flange 26 is compressed to retract the leaves for removal of the device from bottle 16 for drinkable use of the liquid remaining therein.

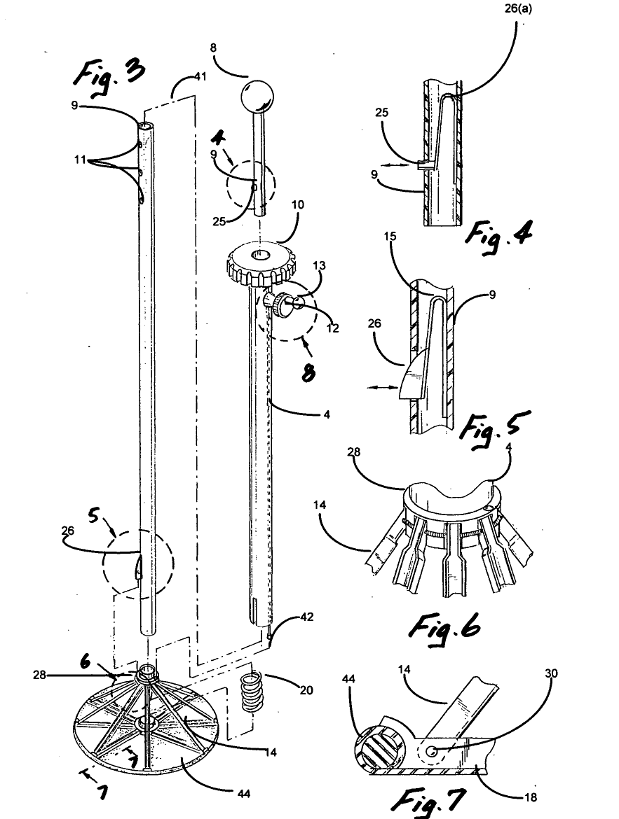

Apertures 11, while providing for air escape while device 2 is in use (as air passes upwardly as it is displaced), also allows for telescopic assembly to enable various levels of fluid in bottle 16, and possesses a single engagement of pin 25 (as shown in FIG. 4) through apertures 11 (noting that the plurality of other apertures are not filled when pin 25 engages but only one of such apertures is in use at any given time). It should be appreciated that pin 25, as well as flange 26 pass through both inner shaft 9 as well as outer shaft 4.

FIG. 3 shows a breakaway view of device 2. In particular, all elements have the same numbers and functions as explained hereinabove. In addition, crank 13, as shown, rotates such that a cable or other structure (braided steel or other like material), is employed for extension and retraction by spools (see FIG. 8) in order to compress and/or extend the fanning-out deployment of hinged leaves 14 as urged by spring 20. (Dotted line 41 shows the assembly of inner shaft 9 into outer shaft 4 and attachment to flange 26.)

Also, as shown in FIG. 3, exploded in FIG. 5, and in action in FIG.'s 13-15, for disengagement upon pressing pin 26 and turning inner shaft 9 via knob 8, spring loaded flange 26 is caused to travel up through inner shaft 9 (thereby disengaging), when inner shaft 9 is turned. Pin 26 is retracted by pressure while holding cap 10 and, by turning knob 8 is caused to remain retracted within the confines of inner shaft 9. Spring 20 is thereby enabled to expand as knob 8 is turned, urging upward movement and collapse of hinged leaves 14, thereby breaking the seal of gasket 44, and allowing the compression of the entire assembly for extraction.

It should be appreciated that cable 42 while cranked by crank 13, is also connected on its downward side to end cap 28 which engages (as shown, e.g., in FIG. 6) leaves 14. In this manner, as cranking occurs, the compression/retraction of hinged leaves 14, which, are as well, engaged by end cap 28 is caused to occur.

As shown in FIG. 4, pin 25 is spring-loaded by spring-steal 26(a) or other springable material within inner shaft 9, thereby providing for spring 20 to press upwardly and ease the re-insertion of the assembly to a cylindrical position of lower diameter than the top of bottle 16. Once inserted, as the device is cranked upwardly via the combination of items 12 and 13, device 2 is compressed into its original position as shown in FIG. 1, for easy extraction providing for drinking from bottle 16 post-extraction.

As shown in FIG. 5 (and in motion in FIG.'s 13-15), likewise spring-loaded flange 26, is also engaged by a springably compressible material 15. When the device is extended, flange 26 is quiescently outwardly displaced in a locked position, and when cranking occurs an otherwise extended, quiescent, flange 26 is caused to engage inwardly via springable material 5, urged against inner shaft 9 such that it unlocks from the slot in outer shaft 4 to disengage to permit via cable 42 of springable retraction to allow extraction of inner shaft 9 to permit extraction of device 2.

As shown in FIG. 6, end cap 28 is moveably affixed to hinged leaves 14 for deployment and retraction, as needed.

FIG. 7 reveals the hinged joinder 30 of hinged leaves 14 to flexible material 18 and, by cross-section, the circumferential gasket 44 for compressable sealability against the inner surface of bottle 16 and against the liquid contained therein.

As explained hereinabove, FIG. 8 shows handle 12 for engagement of crank 13, and, via shaft 38 passes through bearing 40 to spool 43 for spooling rope 42.

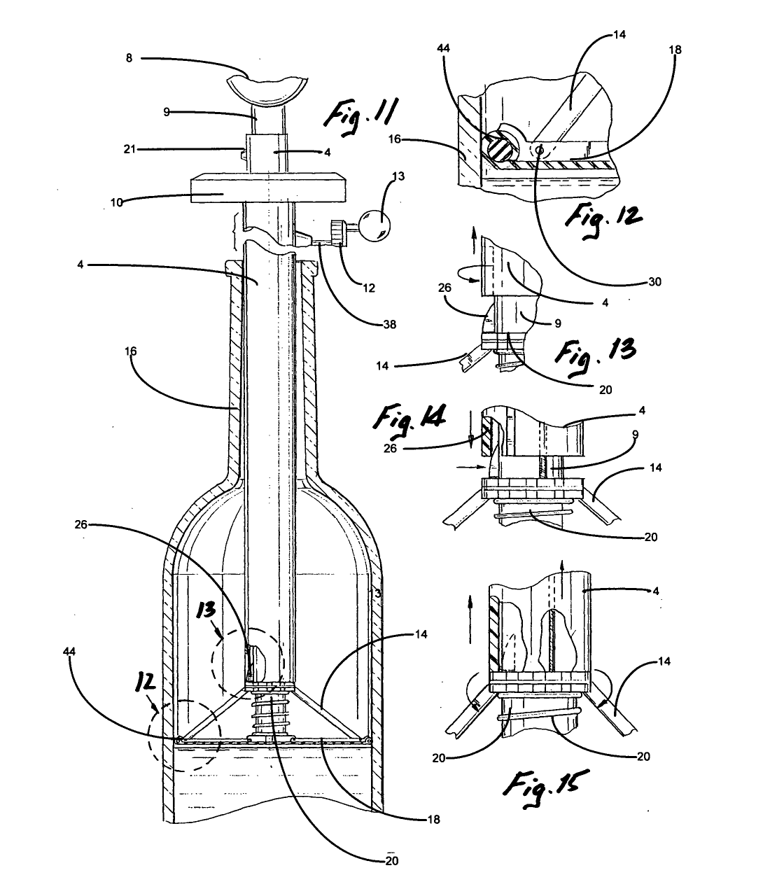

FIG. 9 shows the insertion of device 2, via insertion of external shaft 4, in a quiescent state into the neck of bottle 16. Upon insertion, assemblies 12 and 13, in connection with spring 20 allow the outward extension of flanges 14 with the urging of spring 20, so as to enable the connection. All other items in these drawings bear the same reference numerals as those hereinbefore shown. FIG. 10 shows the same, in the process of deployment.

FIG. 11 shows full deployment against the fluid line in bottle 16. Once extended, internal shaft 9 is twisted so that flange 13 is no longer susceptible to spring-back collapse, unless and until turned by the user to enable extraction.

FIG. 12, again shows a sectional view along circle 12 in FIG. 11, locked in place as shown in FIG. 13. Upon turning of internal shaft 9 via knob 8, flange 26 compresses, the spring urges upwardly, the crank assembly, as shown hereinabove with pulley allows extraction, as shown in FIG.'s 14 and 15.

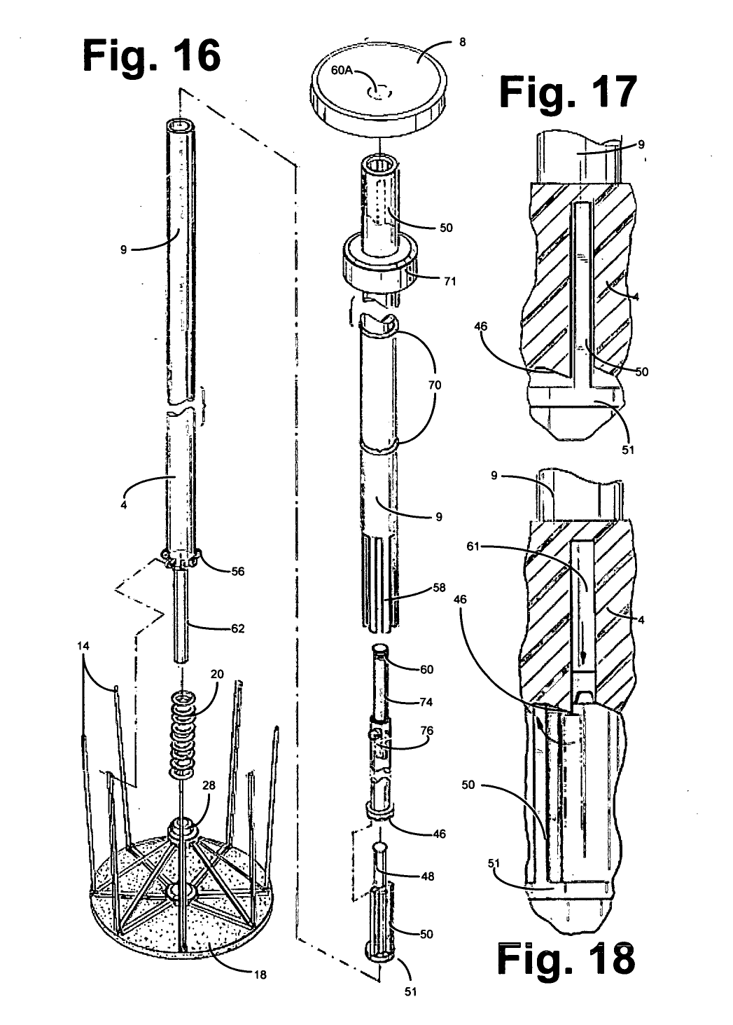

FIG. 16, shows a breakaway of an alternative embodiment of device 2 wherein an extension retraction device is employed comprising a number of different elements as explained hereinbelow. Like the other embodiment, the embodiment shown in FIG. 16 also involves leaves 14, spring 20 (attached to platen 28), flexible material 18, and also shows that spring 20 is urged about pin 62 and against tabs 56, to which leaves 14 are also attached.

In particular in FIG. 16, outer shaft 4 contains an inner shaft 9 in which is inserted the assembly shown by the dotted line in the figure, as explained in greater detail hereinbelow. In particular, as shown by the dotted lines, a flanged assembly is employed for deployment and retraction of leaves 14 via compression and de-compression of spring 20. At the bottom-most region of the insertion into inner tube 9 is a platen 51 which engages spring 20 to cause outward displacement, when in one position, and compression in a second position, as further explained. Above platen 51 are a plurality of vertically mounted coupling elements 50 that have, between them, apertures. Above this assembly is an extension 48 which allows the insertion into the portion demarked 60, 75, and 46, such that insertion and extraction occur, as explained in FIG's 17 and 18. Coupling elements 50 are shown in phantom view in FIG. 17, when the assembly is inserted.

In FIG. 16, coupling device 60 is shown which, when the assembly is inserted, device 60 screwably mounts to cap 8 via 60A (shown in phantom view, as it is below cap 8). Cylindrical element 74, in connection with springable assembly 76, provides telescoping ability to enable deployment at various levels of fluid. Cam 46 engages elements 50, as shown in greater detail in FIG.'s 17 and 18.

In FIG. 16, also shown are channels 59 which provide for leaves 14 to fold therebetween in a recessed stage for estraction. Also shown in FIG. 16 are columnar supports or o-rings 70 which are of flexible material intended to eliminate movement between the internal shaft assembly when inserted into inner shaft 9.

FIG. 16 shows a breakaway view of device 2 whereby clickable mechanism 7 is used to deploy and retract extendable apparatus 6. The user operates clickable mechanism 7 by first pressing on knob 8 which is screwably connected via 60A to shaft 74 via screwing assembly 60. In other words, when pressure is applied, the assembly is forced downwardly in a curved manner (believed as a result of the pressure from spring 20) through the grooves 61 between the vertical elements of coupling element 50, as shown FIG. 18, and engages cam 46 which moves element 50 from either a recessed position as shown in FIG. 17 to an extended position as shown in FIG. 18. When extended (as in FIG. 18), the device is deployed, when retracted, the device is retracted (as in FIG. 17).

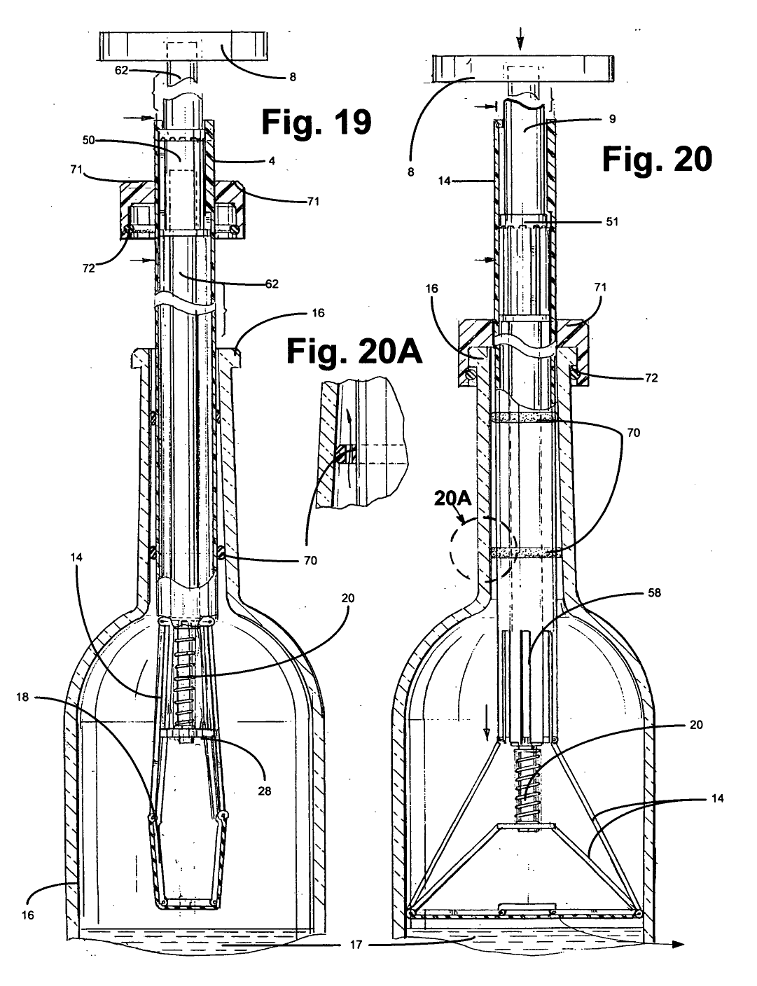

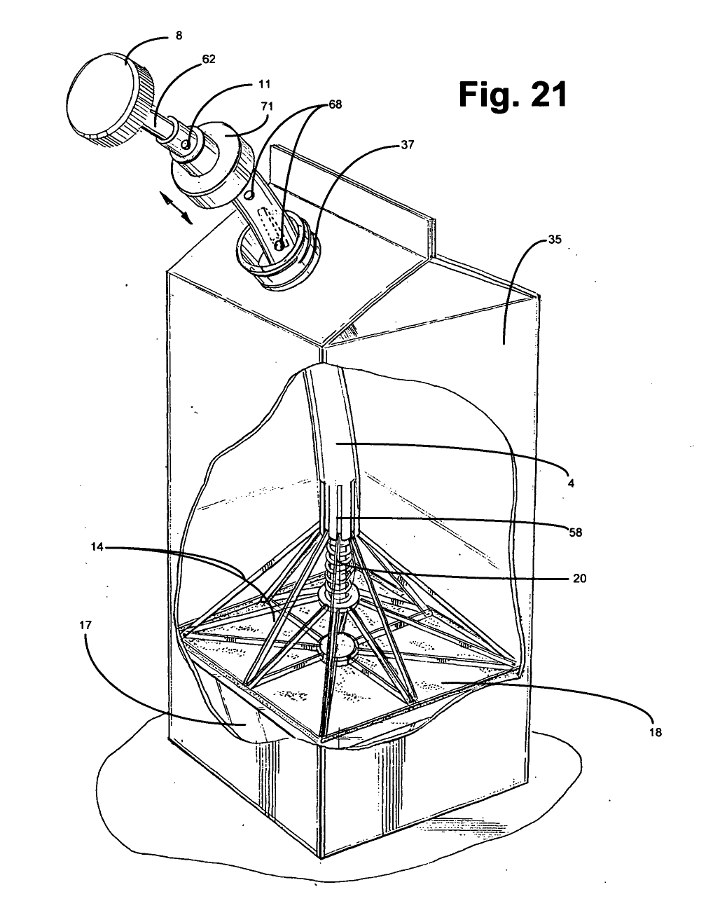

Thus, In FIG. 19, the entire embodiment is shown inserted but not deployed, with columnar supports 71 and gaskets 72 for attachment to the top 16 of the bottle. Like numbers in the drawings refer to the same items. Likewise FIG. 20 shows the embodiment in a partially deployed wherein pressure on cap 8 has caused deployment to commence in accordance with the cammed assemblies described above and shown in the other figures. FIG. 20A shows the o-rings or columnar rings 70 for stabilization of the device.

FIG. 21 shows the embodiment of FIG.'s 16-20 with some minor variations. In particular, knob 8 attaches to internal shaft 62 which has (unshown) a springable clip with detent 11, and openings for variations in size and for air escape 68. In this embodiment stabilization support cap 71 engages screwable assembly 37 for tightening. All other elements are the same, and have the same functions as hereinabove described.

In this manner, when armed with the teachings hereinsetforth, a sealable, reusable device is shown, wherein fanning out of sealable material against the water line is presented, and removable is also provided.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

We claim:

1. A resealable, reuseable, insertable bottle assembly for open beverage containers containing wine, carbonated drink and the like, for preservation against environmental degradation, comprising:
(a) a deployable and retractable flexible material for engagement against the drink;
(b) a plurality of hinged leaved means for engagement with the flexible material at a multiplicity of locations for deployment and retraction further comprising springable means;
(c) coupling means for coupling said hinged leaves;
(d) insertion/extraction means for inserting and extracting the assembly; and
(e) means for causing said leaved means to move from deployment to retraction.

2. The assembly of claim 1, wherein said flexible material further includes gasket means.

3. The assembly of claim 1, further comprising telescoping means for extending and retracting the assembly to enable various levels of drink.

4. The assembly of claim 1, wherein said means for causing said leaved means to move from deployment to retraction comprises cranking means for deploying a cable to enable winding and unwinding for deployment and retraction, respectively.

5. The assembly of claim 3, wherein said telescoping means comprises a plurality of apertures that are engaged by a springably-loaded detente which engages one of said apertures at a given time in order to provide proximity of the assembly to the drink level.

6. The assembly of claim 1, wherein said means for causing said leaved means to move from deployment to retraction consists of a cammed assembly comprising:
(a) a plurality of shafts separated by vacant spaces therebetween wherein the terminal end of each shaft is curved so as to urge consecutive movement from a shaft end to a space such that the assembly is deployed when said terminal end is in said space and retracted when said terminal end is in said shaft space;
(b) a cammed means for interacting with the shafts such that when said cammed means engages the curved terminal end, it is urged consecutively from shaft to space;
(c) wherein said spring presses said cammed means for said urging;
(d) control means for controlling the actions set forth in elements (a) through (d).

7. The assembly of claim 1, wherein said control means is a knob.
